(19) United States
(12) Patent Application Publication
(10) Pub. No.: US 2006/0244602 A1
(43) Pub. Date: Nov. 2, 2006

(54) RFID system and method to monitor a set of objects

(76) Inventor: Mehdi G. Mozafari, Encino, CA (US)

Correspondence Address: CONNOLLY BOVE LODGE & HUTZ LLP, P.O. BOX 2207, WILMINGTON, DE, 19899-2207, US

(21) Appl. No.: 11/118,495

(22) Filed: May 2, 2005

(51) Int. Cl. G08B 13/14

(52) U.S. Cl. 340/572.7

(57) ABSTRACT

The present disclosure relates generally to RFID systems and methods. In particular the present disclosure relates to an RFID system and method for insuring the proximity of the members of a set of designated objects.

### FIELD OF THE INVENTION

The present disclosure relates generally to RFID systems and methods. In particular the present disclosure relates to an RFID system and method for insuring the proximity of the members of a set of designated objects.

### BACKGROUND

The information provided below is not admitted to be prior art to the present invention, but is provided solely to assist the understanding of the reader.

Radio frequency identification (RFID) systems typically include an interrogator, a transponder and a data processor. The interrogator may include an internal microcontroller, a transmitter, a receiver, and an antenna. The transponder is usually a passive device (having no power source) embedded in a card or key tag, and may include an antenna and an RFID application specific integrated circuit (ASIC). The interrogator transmits an electromagnetic wave defining an interrogation field. Upon receipt of electromagnetic energy from the interrogator, the transponder energizes the associated ASIC, which initializes and then broadcasts a coded identity signal. An RFID system may use a low-energy, back-scattering technology that selectively reflects or back-scatters the electromagnetic energy from the transponder back to the interrogator. Receiving circuitry in the interrogator senses and decodes the back-scattered signal to determine the identity of the transponder. Such systems have been used to identify, track and/or locate people or objects.

U.S. Pat. No. 6,842,116, to Hum et al., disclose an RFID system for creating multiple communications path and for extending a communications range beyond the range typical for RFID devices. Hum et al. further disclose means whereby an RFID system may be implemented to give an anti-collision, proximity warning where multiple transponders are in the broadcast range of an interrogator. However, there exists a need for an RFID system to insure that each member of a set is proximately co-located where such co-location is desirable.

Other objects and advantages will become apparent from the following disclosure.

### SUMMARY OF INVENTION

The present invention addresses the perceived needs in the art by providing various aspects.

An aspect of the invention provides an RFID system having an interrogator which communicates with a set of objects each of which is correlated with a transponder. According to an aspect, the interrogator has a microcontroller, a transmitter, a receiver, and an antenna all interconnected and coordinated by means of electronic logic. According to a further aspect the invention provides a correlated set containing at least a first object-transponder pair, wherein each said transponder comprises an antenna and a unique application-specific integrated circuit (ASIC).

According to an aspect, an object member of the correlated set is any object that it is desired to remain in proximity to any other designated object. According to an aspect, each object is affixed to a transponder.

According to an aspect, each transponder has an antenna disposed to receive radio-frequency energy radiated from the interrogator. According to an aspect, a portion of the energy received by the transducer is used to initialize the ASIC. According to an aspect, a portion of the energy received by the transducer is re-radiated, as a carrier-wave, by the transducer antenna. According to and aspect, the ASIC imparts an encoded signal onto the carrier-wave radiated by the transducer antenna. According to a further aspect of the present invention, each encoded signal uniquely identifies a specific ASIC.

According to an aspect, each object-transponder pair further comprises an audible signaling means.

According to an aspect the present invention provides an RFID method to collate a set of objects. According to various aspects the method includes using an interrogator to radiate a field of radio-frequency energy to a correlated set containing at least a first object-transponder pair, energizing an ASIC portion of a transponder using energy received by said at least one transponder, and initializing the ASIC and broadcasting an identity signal therefrom. According to an aspect, the interrogator includes a microcontroller, a transmitter, a receiver, and an antenna. According to an aspect, the transponder includes an antenna and a unique ASIC.

According to an aspect, in response to an interrogation field, the transponder emits an identity signal. According to a further aspect, the identity signal is a coded radio-frequency field. According to a further aspect, the identity signal is an audible tone.

According to an aspect the present invention provides an RFID method to collate a set of objects including determining a non-reporting member of said correlated set; and displaying an indication of said non-reporting member.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a box schematic of an interrogator of the present invention; and

FIG. 2 is a box schematic of a transducer of the present invention.

It is to be noted, however, that the appended drawings illustrate only typical embodiments of this invention and are therefore not to be considered limiting of its scope, for the invention may admit to other equally effective embodiments.

### DETAILED DESCRIPTION OF A PREFERRED EMBODIMENT

Reference is made to the figures to illustrate selected embodiments and preferred modes of carrying out the invention. It is to be understood that the invention is not hereby limited to those aspects depicted in the figures.

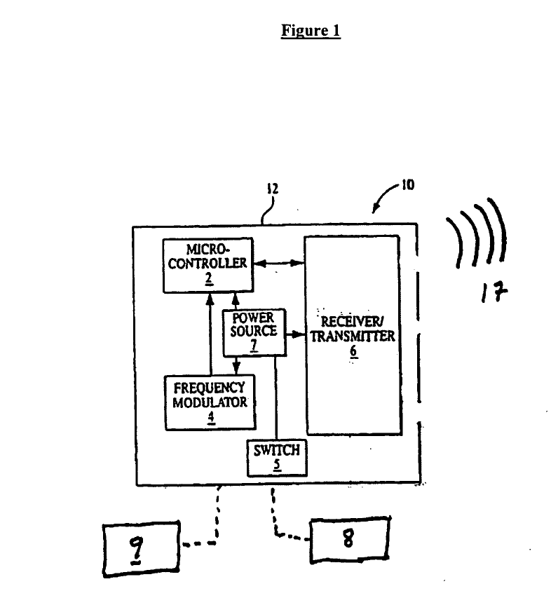

FIG. 1 shows a box diagram of an embodiment of a low-power, short-range communication system 10 for communicating with one or more transponders. Where each transponder is a member of a correlated object-transponder pair. The communication system 10 includes a wireless interrogator 12. The interrogator 12 includes a microcontroller 2 connected to a frequency modulator 4 and to a receiver/transmitter 6. The receiver/transmitter module may include a form of suitable modulation and demodulation circuitry to condition/modulate the interrogation signals with the correct amount of power and security and within a certain bandwidth around a particular center frequency for transmission, and to receive using demodulation techniques the transponder response signals with an acceptable level of signal accuracy and integrity. In addition, error correction features may be used. A power source 7 may be connected to each of the other circuit elements and to a switch 5 that may be utilized by a user to activate the interrogator 12. The interrogator may also include or be connected to an output device 8 that may be used to indicate information to the user, such as the presence of transponders or to store data received from a particular transponder for later analysis, or to process the data. The interrogator 12 may also include, or be connected to, a data input device 9 that may be used to enter data or information to the interrogator, or to send data or information to a transponder, or both. Thus, the input device may be used for various purposes, such as updating information, or loading a new version of software or for data transmission and/or to request data retrieval. The interrogator 12 generates interrogation signals 17 that are wirelessly broadcast directly from the interrogator (from an antenna not shown).

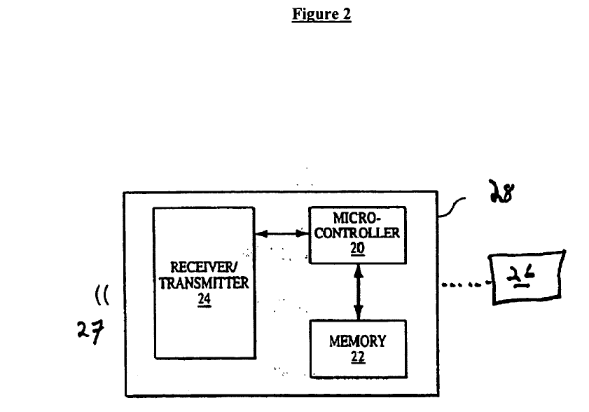

FIG. 2 is a simplified block diagram of an embodiment of transponder 28 of a type that may be used in the communication system 10 of FIG. 1. The transponder 28 may include a microcontroller 20 connected to a memory 22 and to a receiver/transmitter 24 which may contain modulation and demodulation circuitry. The transponder 28 may alternately be fabricated as an ASIC on a single silicon chip including a receiver/transmitter and controller circuitry along with a memory element. The memory may store an identification code, or other data related to a particular object to which it corresponds. The transponder is typically a passive device, but may include a battery source. A passive transponder absorbs energy to power its circuitry from the received interrogation signals. The transponder may also be configured to collect data from the object or item that it is associated with for later transmission to the interrogator. Thus, the transponder may be a read-only or a read/write type. The receiver/transmitter 24 rectifies the energizing RF field into direct current (DC) and powers up the microcontroller 20. The microcontroller then initializes and transmits an identification code and/or other data from its memory to the interrogator.

An embodiment provides a method for collating a set of objects. In the method, a transponder, having a unique ASIC-generated code, is affixed to each object-member of the set. As the objects are used and/or stored they may become scattered and not co-located. To find and locate the objects, a user employs a method embodying the present invention. The user turns on interrogator 12 such as by depressing switch 5. A user may operate input device 9 to initialize software functions stored in a memory portion of microcontroller 2. Under software program control by microcontroller 2, interrogator 12 then generates and transmits a first interrogation signal 17. In this scheme, each interrogation signal may differ from another to distinguish between transponders. The goal is to locate where each transponder is in the system. For example, the interrogator may generate signals of different radio frequencies, signals having different amplitudes, signals of different power strengths, or other signal types including signals that include different combinations of characteristics, such as using modulation schemes like Amplitude Modulation (AM), Manchester Coding, or any other modulation schemes. Each different interrogation signal corresponds to a particular transponder of the system, and each transponder corresponds to a different object-member of a correlated set. The interrogation signals for the different transponders are sent in sequence or in some other manner that permits them to be distinguished from one another. Next, the interrogator determines 58 whether or not a first transponder (n=1) has responded. If a response is received from the n=1 transponder, the interrogator increments a counter and interrogates an n=2 transponder. If the n=1 transponder has not responded, the interrogator retrieves from memory an error message and the name of the object associated with the n=1 transponder and writes the error message and object name to output device 8. The interrogator then increments a counter and interrogates an n=2 transponder. The interrogator iteratively interrogates each transponder in sequence and displays error messages as appropriate. In an embodiment, where one or more transponders fail to respond, the interrogator may repeat the sequence of interrogation signals, but limited to the non-responding transducers. A user may read output device 9 to be reminded of a missing object.

According to an embodiment, the method includes using an interrogator to radiate a field of radio-frequency energy to a correlated set containing at least a first object-transponder pair. The transponder uses a portion of the received radio-frequency energy to energize and initialize an ASIC portion. The ASIC impresses a signal onto a carrier wave emitted by the transducer antenna. The ASIC encodes an identification signal unique to the individual ASIC. In an embodiment, a signaling device is associated with the transducer. The signaling device may be electrically connected to the transducer. Preferably, the signaling device is integrated into the transducer structure. The signaling device may emit a light signal. Preferably, the signaling device emits an audible sound. In embodiments where a signaling device is present, activation of the ASIC causes the emission of a signal. A user may use the signal to determine a location of the associated object.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

### Incorporation by Reference

All publications, patents, and pre-grant patent application publications cited in this specification are herein incorporated by reference, and for any and all purposes, as if each individual publication or patent application were specifically and individually indicated to be incorporated by reference. In the case of inconsistencies the present disclosure will prevail.

1. An RFID system comprising:
an interrogator comprising: a microcontroller, a transmitter, a receiver, and an antenna; and
a correlated set containing at least a first object-transponder pair, wherein each said transponder comprises an antenna and a unique ASIC.

2. The RFID system, according to claim 1, wherein each said object-transponder pair further comprises an audible signaling means.

3.

4. An RFID method to collate a set of objects comprising:
providing an interrogator comprising: a microcontroller, a transmitter, a receiver, and an antenna;
using said interrogator, radiating an interrogation field to a correlated set containing at least a first object-transponder pair, wherein each said transponder comprises an antenna and a unique ASIC;
energizing said ASIC using energy received by said at least one transponder;
initializing said ASIC and broadcasting an identity signal therefrom.

5. The RFID method to collate a set of objects, according to claim 4, wherein said identity signal is a coded radiofrequency field.

6. The RFID method to collate a set of objects, according to claim 4, wherein said identity signal is an audible signal.

7. The RFID method to collate a set of objects, according to claim 5, further comprising:
determining a non-reporting member of said correlated set; and
displaying an indication of said non-reporting member.
